(19) United States
(12) Patent Application Publication
(10) Pub. No.: US 2010/0152774 A1
(43) Pub. Date: Jun. 17, 2010

(54) Pacifier/ protection from all surfaces

(76) Inventor: Christopher Douglas Branham, Blacklick, OH (US)

Correspondence Address: CHRIS BRANHAM, 179 MALLOY LN, BLACKLICK, OH, 43004, US

(21) Appl. No.: 12/381,969

(22) Filed: Dec. 16, 2008

(51) Int. Cl. A61J 17/00; B23P 17/04

(52) U.S. Cl. 606/236; 29/428

(57) ABSTRACT

The pacifier guard is made of a polymer compound silicone base easily cleansed, designed to continuously protects the nipple from germs on different surfaces. Made of the same silicone base material as the exterior, the nipple is connected to the external polymer silicone base element of a flexible material, generating a stronger design. Flexible appendages are individual shields of the external component, attached to the exterior silicone guard expanding once pressure is applied decreasing as pressure is removed. The dome shaped exterior (such as 53 of FIG. 1) creates a protective umbrella over the nipple increasing the chances of nipple protection. Located in the center is the guard and loop combination (such as 51 of FIG. 1), designed to prevent choking regarding child safety and the loop for easy removal from the child's mouth.

### BACKGROUND OF INVENTION

1. Field of the Invention

The invention is intended for infants and toddlers as a soothing apparatus. This baby product is a design to protect small children from harmful germs and materials that come in direct contact with the nipple. This invention is limited to a specific age group of children regarding the growth and shape of their teeth and gums.

2. Description of the Related Art

Pacifiers are a large part of every child's young developmental years, utilized by parents to keep a child calm and relaxed. Several designs have been created that are currently on the market, some are used specifically for soothing the child, others are designed to keep the nipple from coming in contact with the ground and several are designed for decoration and/or fashion statements. The nipple is the significant component of the pacifier used as a false representation of a female nipple as a form of nurturing; a very important part to the pacifier design however not the key component to the invention.

All pacifiers are required to have a guard attached to the nipple to prevent the child from swallowing the nipple and choking. The guard is made of a plastic material which is attached to the nipple, recently there have been several recalls regarding nipples becoming unattached from the guard and children choking on the nipple. This invention attaches the guard and nipple together in a more effective way; eliminate the issue of a child choking on a pacifier nipple. Attachments such as clips, nylon straps, buttons and Velcro have been added to the pacifier design to keep the nipple from coming in contact with harmful materials on different surfaces. The previous attempts to protect the nipple have areas of concern that were over looked. A child crawling on the ground and the pacifier attached to their clothing will contaminate the nipple and will eventually need to be cleansed with soap and water. The use of a cap over the nipple is very efficient but the cap has the potential of becoming lost over a period of time. Having to continuously wipe off a pacifier nipple because it has been dropped is tedious. Wiping the pacifier off on an article of clothing, or rinsing the nipple off for a moment is the typical solution employed by parents/ guardians to keep their child safe from germs and foreign materials.

### BRIEF SUMMARY OF THE INVENTION

A sanitary baby product is the goal of this device, protecting the nipple of the pacifier by using flexible appendages located of the outer rim of the pacifier device. Made of a washable material (polymer compound), that is easily cleansed with soap and water will continuously protect the nipple from harmful dust particles and germs on diverse surfaces. The nipple is connected to the external guard made of a flexible compound; using a molding process, producing a stronger more durable pacifier as regards to the safety of the device, creates this. Once the nipple is inserted into the child's mouth, germs and harmful materials that are established on the nipple have the opportunity to affect the child's immune system. The health of the child is very important in the growth process; vitamins, scheduled doctor shots and proscribed medication(s) are all necessary items. As an infant the pacifier is often in the child's mouth more then a bottle or any other foreign object. Recently several toys and pacifiers have been considered to be unsafe due to certain creative processes in the design procedures for the final product. This pacifier design was inspired by the neglect of previous pacifiers and baby products released on the open market. The shape of this pacifier exterior is very important, creating a protective umbrella over the nipple increasing the chance of a sanitary pacifier nipple. Other pacifier designers have come up with ideas and concepts of how to cover and protect the nipple, developing a device that improves the chances of safeguarding the child. This pacifier will protect the nipple from harmful surfaces, germs and foreign particles. The materials used in this pacifier design are child safe, all facets required for pacifiers are located this baby product. The overall function of the pacifier nipple has not changed although the functionality and external design is unique and purpose driven, creating a new way of thinking regarding child safety and protection from all foreign particles and harmful germs.

### BRIEF DESCRIPTION OF THE DRAWINGS

FIG. 1 is a perspective view of the present pacifier invention illustrating all the elements required in the choice design.

FIG. 2 is a side view of the present pacifier invention exemplifying the preferred shape and location of the necessary air hole(s) passages.

FIG. 3 is a top view of the present pacifier invention, depicted are the air hole(s) and guard located directly overtop of the nipple.

FIG. 4 is a perspective view of the present pacifier invention describing the importance of how the nipple and appendage(s) are attached to the center of the pacifier as a whole functioning mechanism.

FIG. 5 is a transparent perspective view of the present pacifier invention showing the internal parts and how the external pacifier and guard coincide as a whole element.

FIG. 6 is a top view and side view of the protective pacifier guard invention showing the shape of the guard and protruding loop located on the top of the guard.

FIG. 7 is an exploded view of the present pacifier invention illustrating the external pacifier mechanism and the pacifier guard as separate entities and how they are joined together.

FIG. 8 is a series of process views of the present pacifier invention representing the step-by-step actions required to make the mechanism function properly.

### DETAILED DESCRIPTION OF THE INVENTION

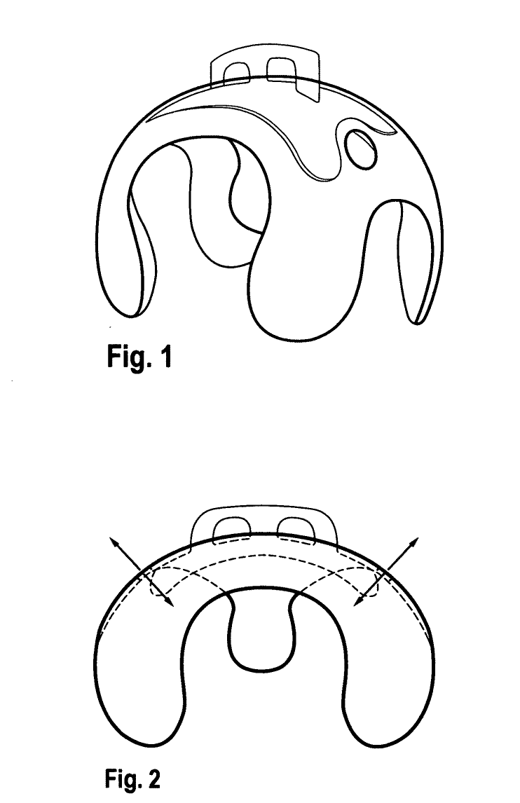

Overview: In FIG. 1, Pacifier 12 has a external casing 14 made of a flexible material that is child safe and durable for extensive use over time, with multiple flexible appendages (15a, 15b, 15c, 15d) affixed to the flexible external casing 14 designed to surround the nipple component 21 which is connected to flexible membrane 14 as well. Ventilation holes 13 and 16 are incised in flexible casing 14 added to prevent child suffocation. The internal pacifier guard 23 is attached to loop 27, affixed in the flexible exterior 14, a safety mechanism required of all pacifier designs.

Using different materials of a polymer compound creating the guard and loop combination as well as external blends of shapes and patterns. The flexibility is produced from the external profile while the rigidity is represented from the imitated dome shape supported by a polymer compound. Each external extension imparts a safety quality that is often represented by a cap or cover attached by a snap or fastener. A necessary precaution positioned in the center of the external casing is the polymer guard. An internal guard devise located in the center necessary in all pacifiers as a safety precaution.

The external flexible membrane has a dome shape intended to keep form indefinitely, improving the structure and protective attributes of the safety process. The appendage(s) strengthen the flexible membrane increasing the overall safety of the nipple component. These two features will enhance the security of the nipple component located in the center of the flexible membrane. The exterior provides several forms of protection utilized in the devise with a soft lip continuously around every edge. This invention should be understood that this pacifier is significant in the development of the child and protection of their immune system.

Pacifier Assembly: In FIG. 2, Pacifier 30 has a die-cast polymer compound flexible membrane 32 specifically designed for nipple protection and durability, continual safety once the pacifier is removed from the child's mouth. Multiple die-cast polymer flexible appendages (33a, 33b, 33c, 33d) located on the lip of the flexible exterior fused to flexible membrane 32 expanding the exterior while increasing the security of the nipple shielding against any harmful material, flexible for comfort and peripheral stability preserving important pacifier elements. Nipple component 39 is related to flexible membrane 32 located on the underside surrounded by flexible appendages (33a, 33b, 33c, 33d). Embed in flexible membrane 32 is guard 35 for safety precautions contributing to the formation of membrane 32. Loop 37 is affixed to guard 35 allowing the guardian a fixed handle to remove the pacifier safely. Loop 37 and guard 35 are made as a solitary part then inserted within flexible membrane 32. Ventilation holes are perforated into membrane 32 designed to prevent child suffocation.

Flexible membrane 32 interacts with flexible appendages (33a, 33b, 33c, 33d); once pressure is applied to membrane 32 flexible appendages (33a, 33b, 33c, 33d) expand increasing vulnerability near nipple component 39, present effortless insertion in the child's mouth. The invention of this figure is to illustrate a preferred methodology of casting a pacifier created to prevent unambiguous use and safety, simplistic design exploiting a vital precaution insinuating shelter while quiescent. Flexible membrane and appendages prevent nipple contamination, increasing the health of the child.

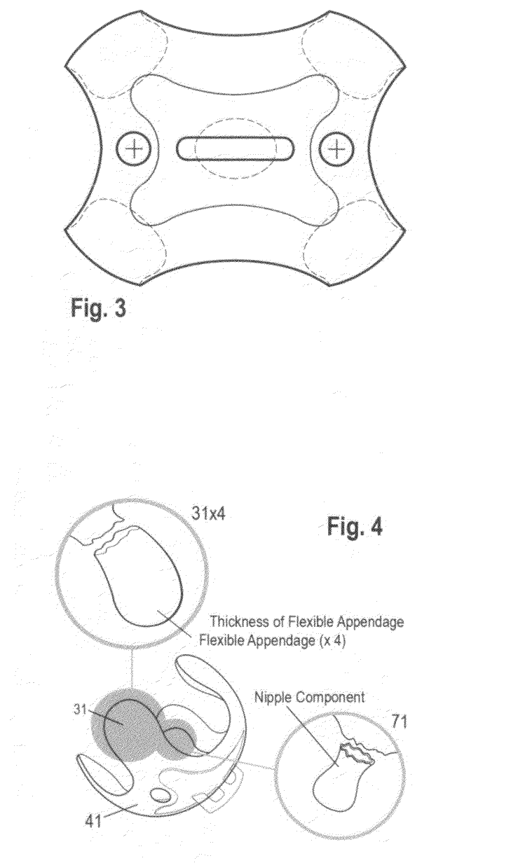

Flexible Exterior: FIG. 3, Flexible member 52 has an exterior derived from a polymer compound, a smooth curved design encompassing the nipple in the core of the flexible member 52. The appendage (s) (73a, 73b, 73c, 73d) wrap around the nipple component constructing a stronger barrier against harmful materials. Produced as one individual unit, entirely composed of a polymer compound for strength, comfort, durability and longevity. Ventilation hole(s) 75 are located horizontal from each. Each appendage (73a, 73b, 73c, 73d) has a slight thickness supporting the safety of the nipple, pointed inward shielding the important element against several harmful items. Member 52 has a thickness intended to facilitate the general contour utilizing flexibility and rigidity while exploited or dormant.

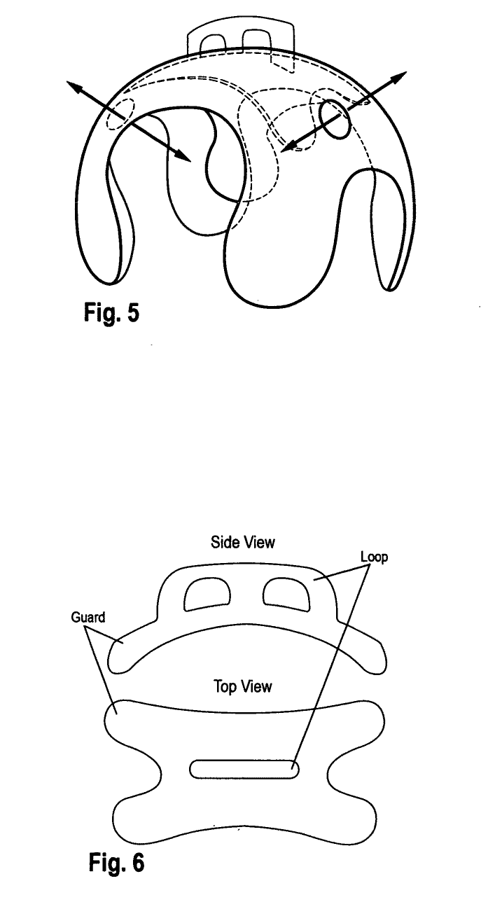

Method of Manufacturing: FIG. 4, Guard 51 is located in the center of flexible member 53 increases the strength of the pacifier. By increasing the structure of the design allows the pacifier to become more durable. The process employed to place guard 51 in flexible member 53 is described as die-casting. The definition of this procedure is to make a plastic or metal object by pouring or forcing molten plastic or molten metal into a mold, this pacifier invention is made of a polymer compound used to develop the flexible member 53 and guard 51. Guard 51 is formed within a mold to the specifications of the final design as well as flexible member 53. Guard 51 is embedded within flexible member 53 using the die-cast process, a relatively easy method to achieve a unique pacifier invention.

Method of Use: FIG. 5, Describes the method of use. Step 1 of FIG. 6 illustrates the pacifier and the proper why the pacifier ought to be held. Step 2 of FIG. 6 illustrates the second action as the parental guardian applies pressure to flexible member 101 expands, once flexible member 101 has been increased to its desired volume, only then the nipple component 102 is inserted into the child's mouth illustrated in step 3 of FIG. 6.

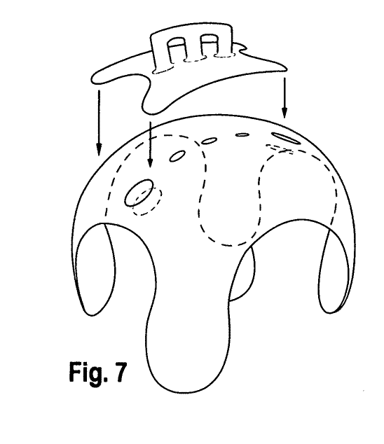

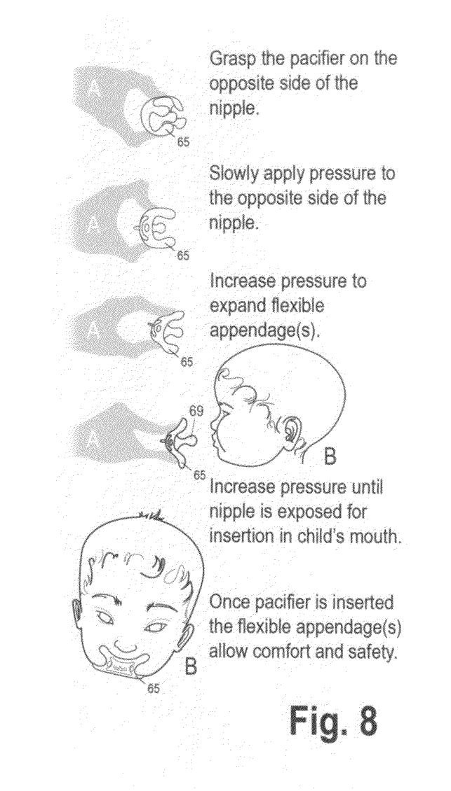

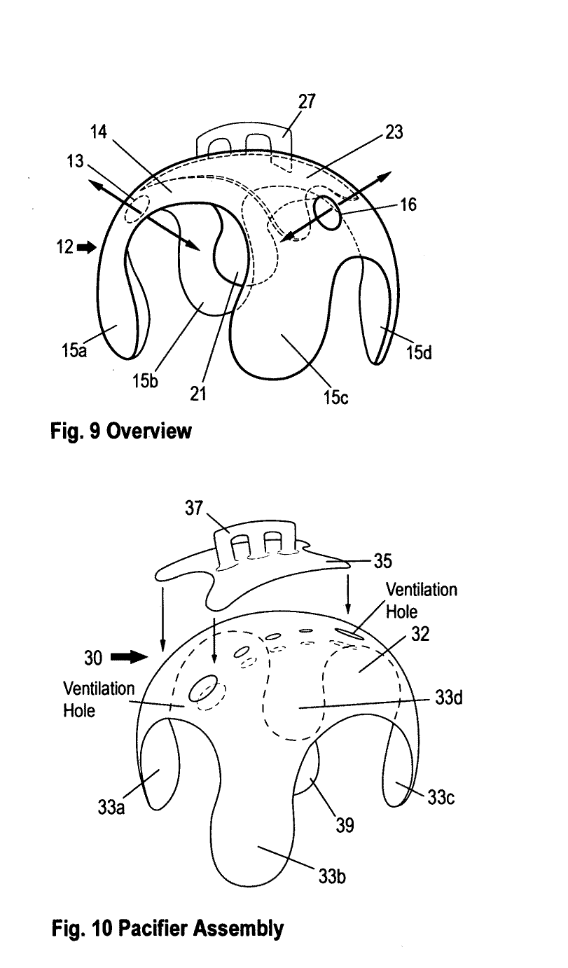

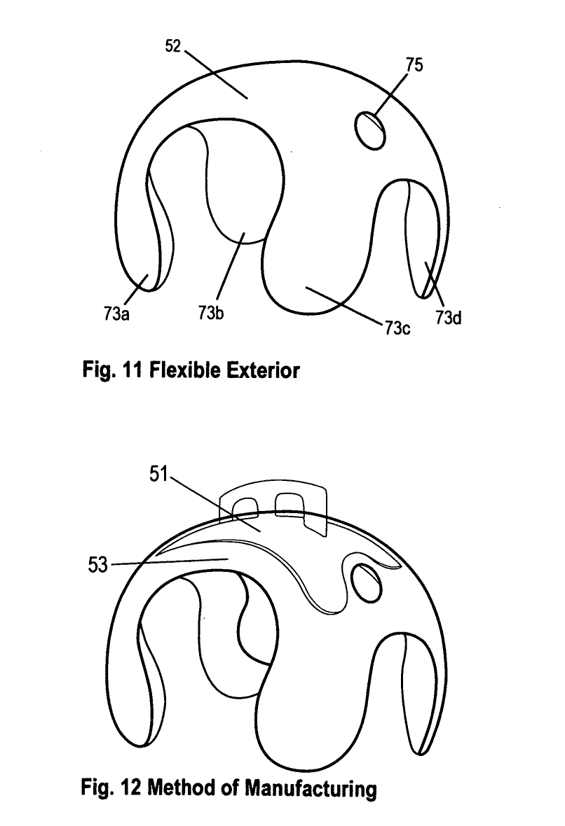

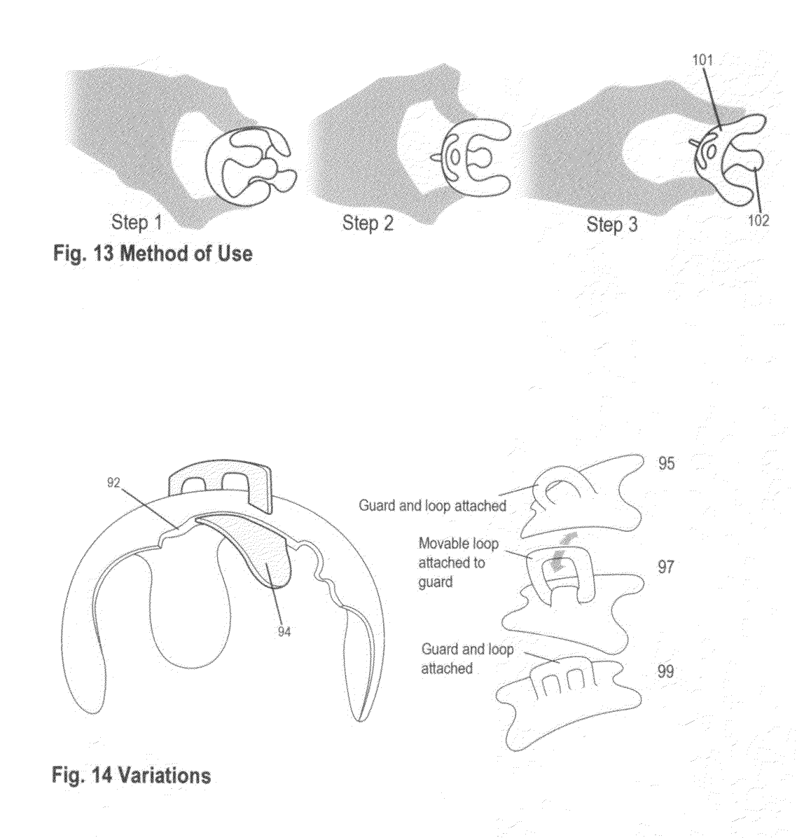

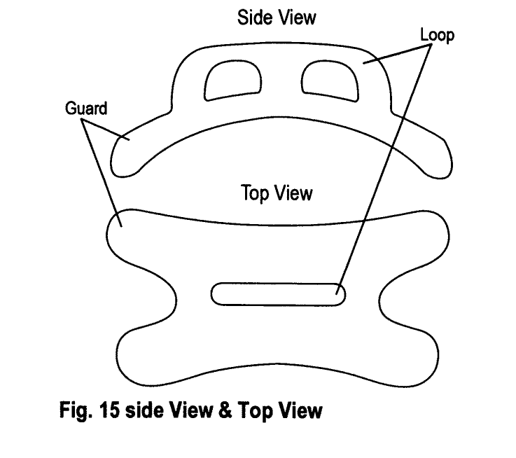

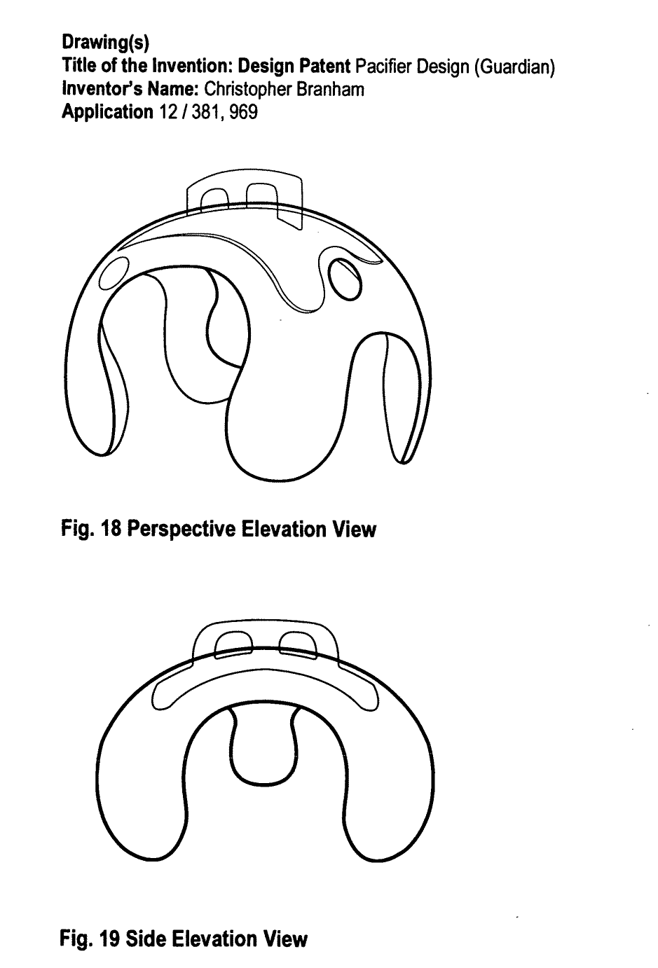

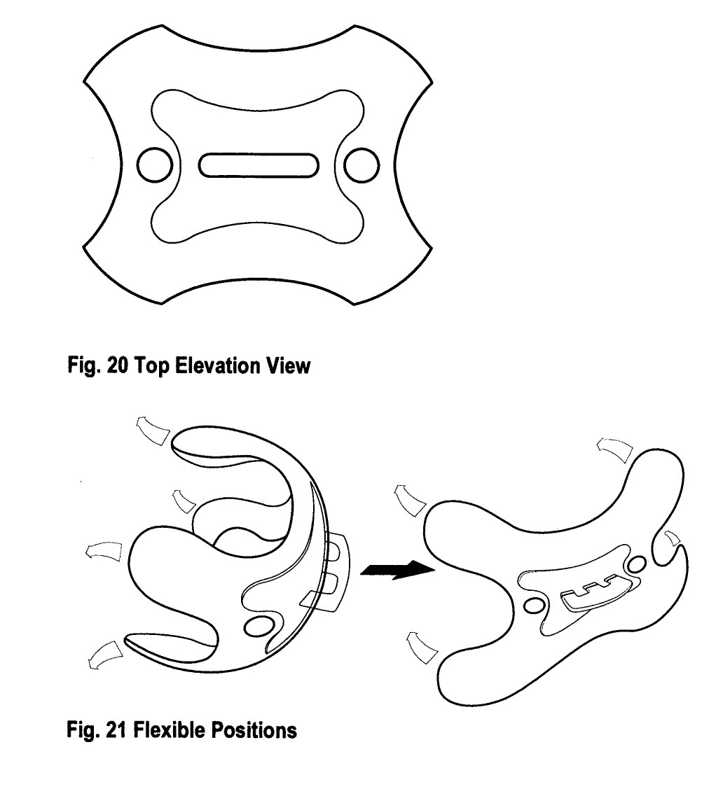

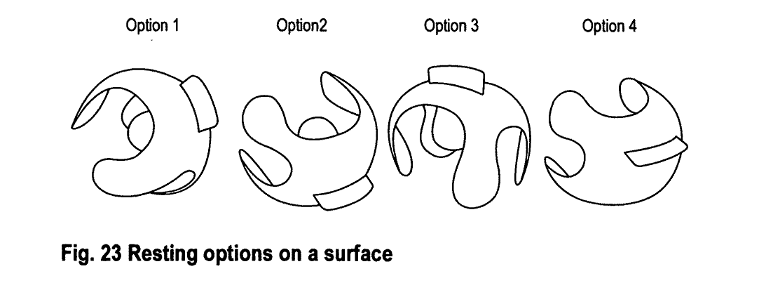

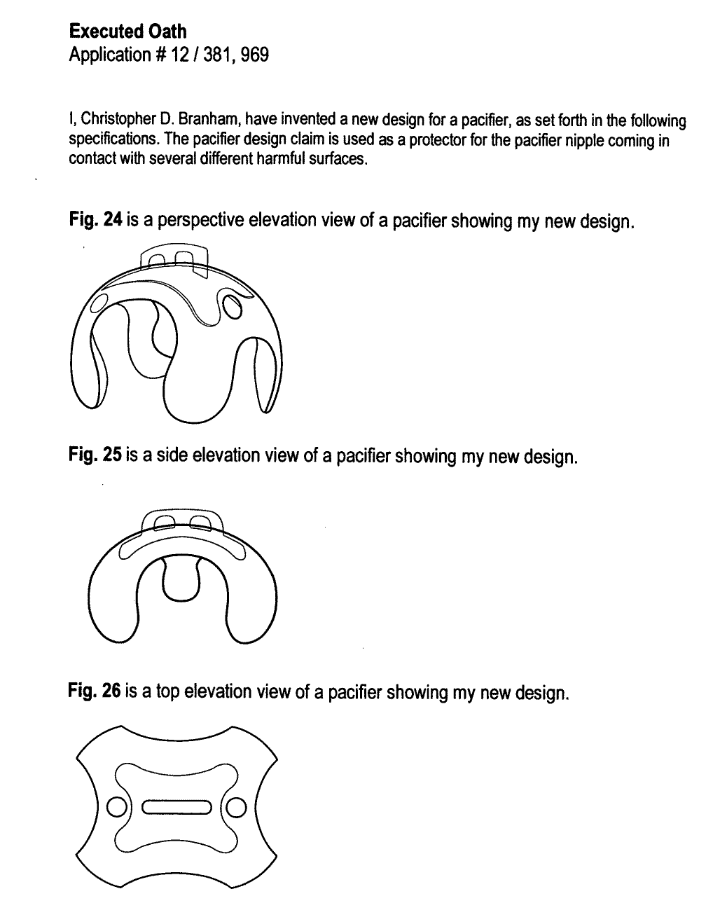

Variations: FIG. 6, Illustrates various models of the inserted guard. Model 95 of FIG. 6 illustrates the guard and single loop merged to create a solid safety device. Image 97 of FIG. 6 divides the loop and guard as a two separate elements, the loop can shift on a pivot centered on the guard. Representation 99 of FIG. 6 describes illustration 95 as a double loop design merged to create a solid safety unit. Image 92 of FIG. 6 shows the thickness needed to envelop shield 94 of FIG. 6. FIG. 7, Illustrates guard and loop joined together as a solitary device giving the idea of a top and side view.

1. A pacifier gadget, comprising:
a loop;
a guard attached to said loop;
a flexible member connected to said guard;
a fin appendage attached to said flexible member; and
a nipple component attached to said flexible member.

2. The pacifier gadget of claim 1, wherein loop is attached to said guard.

3. The pacifier gadget of claim 1, wherein said guard is affixed to said flexible member.

4. The pacifier gadget of claim 1, wherein said fin appendage is connected to said flexible member.

5. The pacifier gadget of claim 1, wherein said nipple component is connected to said flexible member.

6. A process of manufacturing a pacifier gadget, comprising;
a) securing said loop and said guard as a die-cast single unit;
b) ring said single unit of claim 6 (a) in female die-cast mold;
c) attaching said flexible member, said fin appendage and said nipple component as a die-cast single unit to said claim 6 (a).
d) affixed said claim 6 (a) to said claim 6 (c) as a two-part die-cast single unit.

7. The process of claim 6, including testing said pacifier gadget.

8. A method of using a pacifier gadget, comprising;
a) grasping said pacifier gadget;
b) activating flexible member and fin appendage;
c) insert nipple component in users mouth.

9. The method of claim 8, wherein said activation of pacifier gadget flexible member and fin appendage is human initiated.

10. A loop and guard, comprising:
said loop and said guard are comprised of a polymer compound.

11. The flexible member, fin appendage and nipple component, comprising:
wherein said flexible member, said fin appendage and said nipple component is comprised of a polymer compound.

12. Wherein said loop and said guard are embed by die-cast process within said flexible member.

13. Wherein said loop is a protrusion beyond said flexible member exterior.
